(19) United States
(12) Patent Application Publication
(10) Pub. No.: US 2026/0056031 A1
(43) Pub. Date: Feb. 26, 2026

(54) ROUTE GUIDANCE SERVICE APPARATUS

(71) Applicant: INAVI SYSTEMS CORPORATION, Seongnam-si, Gyeonggi-do (KR)

(72) Inventors: Eun Il LEE, Gunpo-si (KR); Taeg Han KIM, Yongin-si (KR)

(73) Assignee: INAVI SYSTEMS CORPORATION, Seongnam-si, Gyeonggi-do (KR)

(21) Appl. No.: 19/102,660

(22) PCT Filed: Aug. 8, 2023
(86) PCT No.: PCT/KR2023/011637

§ 371 Date: Feb. 10, 2025

(30) Foreign Application Priority Data
Aug. 8, 2022 (KR) 10-2022-0098512
Aug. 1, 2023 (KR) 10-2023-0100708

(51) Int. Cl. G01C 21/00; G01C 21/36; G06F 16/29

(52) U.S. Cl. CPC G01C 21/3889; G01C 21/3667; G01C 21/3697; G06F 16/29

(57) ABSTRACT

An electronic apparatus according to an embodiment, disclosed in the present document, includes: a memory storing first map data of a first resolution; a communication module communicating with an external electronic apparatus, the external electronic apparatus storing second map data of a second resolution higher than the first resolution and related to a three-dimensional shape; and a processor. The processor may: identify route information based on the first map data; transmit, to the external electronic apparatus, a first message related to a request for requested item information according to the processing performance of the electronic apparatus and a portion of the second map data, which corresponds to the route information, from among the entire second map data; and in response to the first message, receive, from the external electronic apparatus, the requested item information and the portion of the second map data corresponding to the route information.

### TECHNICAL FIELD

This research was conducted as part of Innovation Project for Autonomous Driving Technology Development (20018198) supported by Ministry of Trade, Industry and Energy and Korea Evaluation Institute of Industrial Technology.

Various embodiments disclosed in this document are related to a high precision map provision technology.

### BACKGROUND ART

A route guidance apparatus evolves from simply displaying only a road form through a two-dimensional map, and may support a user so that the user can easily find a destination by providing a shape of a building around a road through a three-dimensional map.

Meanwhile, in a new industry field, there is an increasing demand for a three-dimensional high-precision map (e.g., HD MAP). For example, an autonomous vehicle requires lane or signal information and information, such as a road and the height of a facility for its safe driving. According to such a demand, Ministry of Land, Transport and Maritime Affairs is embodying a cyber land (three-dimensional map data) similar to the real world as height and image information is added to the existing two-dimensional map data.

### DISCLOSURE

### Technical Problem

Three-dimensional high-precision map data may provide much more detailed information than two-dimensional map data, but have disadvantage in that the amount of data is massive and a computational load for processing is greatly increased. Accordingly, it may be difficult for a low-specification electronic device to store, use, or display three-dimensional high-precision map data.

Various embodiments disclosed in this document may provide a route guidance service apparatus capable of outputting some of high-precision map data.

### Technical Solution

An electronic device according to an embodiment disclosed in this document includes memory in which first map data provided to have first resolution are stored; a communication module provided to be capable of communicating with an external electronic device, wherein the external electronic device stores second map data provided to have second resolution higher than the first resolution and related to a three-dimensional shape; and a processor functionally connected to the communication module and the memory. The processor may check route information retrieved based on the first map data when route search is performed, may transmit a first message related to a request for some of the second map data corresponding to request item information according to processing performance of the electronic device and the route information, among all of the second map data, to the external electronic device through the communication module, and may receive some of the second map data corresponding to the request item information and the route information, as a response to the first message, from the external electronic device through the communication module.

Furthermore, an electronic device according to an embodiment disclosed in this document includes a communication module provided to be capable of communicating with an external electronic device, memory in which first map data including three-dimensional shape information are stored, and a processor functionally connected to the communication module and the memory. The processor may check route information on a destination and request item information corresponding to processing performance of the external electronic device through the communication module when the external electronic device transmits the route information and the request item information, may select first map data related to the route information, among all of the first map data, may determine some of the first map data corresponding to the request item information by excluding information except the request item information from the selected first map data, and may transmit the some of the first map data to the external electronic device through the communication module.

### Advantageous Effects

According to various embodiments disclosed in this document, some of high-quality map data can be selectively provided. In addition, various effects which may be checked directly or indirectly through this document may be provided.

### BRIEF DESCRIPTION OF DRAWINGS

FIG. 1 is a construction diagram of the route guidance system according to an embodiment.

FIG. 2 is a construction diagram of a user device according to an embodiment.

FIGS. 3, 4, and 5 are examples of route guidance screens according to an embodiment.

FIG. 6 is a construction of a server device according to an embodiment.

FIG. 7 is a flowchart of a route guidance method according to an embodiment.

In relation to the description of the drawings, the same or similar reference numeral may be used for the same or similar component.

### MODE FOR INVENTION

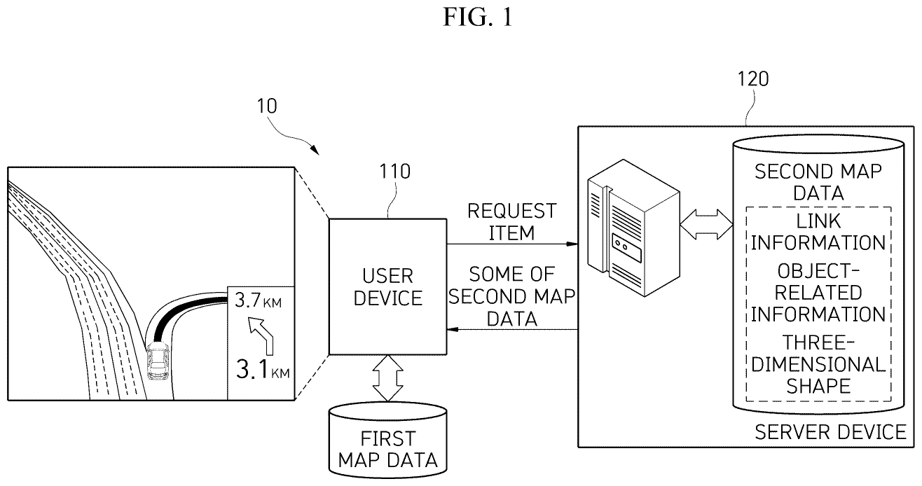

FIG. 1 illustrates a construction diagram of the route guidance system according to an embodiment.

Referring to FIG. 1, a route guidance system 10 according to an embodiment may include a user device 110 and a server device 120. In an embodiment, some components of the route guidance system 10 may be omitted or an additional component may be further included in the route guidance system. Furthermore, some of the components of the route guidance system 10 may be combined into one entity, but may identically perform a function of corresponding components prior to the combination. For example, the user device 110 may include an output device and a sensing device which are provided as separate devices. For example, the server device 120 may include a database device in which second map data have been stored and a processing device, which are provided as separate devices.

According to an embodiment, the user device 110 may include at least one device, among an autonomous driving device, a head-up display (HUD), a built-in navigation, external navigation, a portable terminal (e.g., a smartphone), or a small-sized monitor. In an embodiment, the user device 110 is mounted or provided on a vehicle (or another moving body), and may provide guidance to a route to a destination through an output device that is included in or connected to the vehicle (or another moving body).

According to an embodiment, the user device 110 may store first map data having first resolution. The first resolution may be standard definition (SD) or high definition (HD), for example. However, the present disclosure is not limited thereto. In this document, a case in which the first resolution is SD is described as an example, for convenience of description.

According to an embodiment, the user device 110 may search for a route based on the first map data in response to a route search request from a user. The user device 110 may check route information on the search route and may generate (or determine) the route information based on the first map data. The route information may include the link ID of a link according to a standard node link that connects nodes according to the standard node link included in the first map data, for example. The route information may include current location information (e.g., geographical location coordinates, a driving direction, or a driving lane (e.g., a three-lane road)) and lane change information of a vehicle or may be related to the current location information and the lane change information. In this document, a case in which the route information includes current location information and lane change information is described as an example, for convenience of description.

According to an embodiment, the user device 110 may confirm: request item information corresponding to preset processing performance. The request item information may be set by a user, and may be automatically set based on the processor specifications of the user device 110. The request item information may include at least piece of information, among information on the type of object to be requested, information on the number of requested lanes (hereinafter corresponding to a “designated number”), information on requested resolution, and information on the use/unused status of a three-dimensional shape image, for example. The type of object may include at least one object, among a lane, a road, a road facility (e.g., a traffic sign, a traffic light, or a curbstone), a signal state (e.g., a traffic light turn-on/blinking state), a traffic state (e.g., congested or slowing down), a surrounding facility (e.g., a gas station or a restaurant), a varying object (e.g., a sink hole or shards of an accident vehicle), for example.

According to an embodiment, the user device 110 may transmit the request item information and the route information to the server device 120, and may receive some of the second map data corresponding to the route information (e.g., a link id) and the request item information from the server device 120 as a response thereto. The second map data provided to have second resolution (e.g., HD) higher than the first resolution may include at least one object, among a lane, a road, a road facility, a surrounding facility, and a varying object, in the form of a three-dimensional shape image. The second map data may include a signal state (e.g., a traffic light turn-on/blinking state) and a traffic state (e.g., congested or slowing down) that is incorporated in real time or may be related to the signal state and the traffic state. The some of the second map data may include a section corresponding to a current location according to the route information, among all of the second map data. The some of the second map data may include an object having a type corresponding to the request item information in the second map data as resolution and a shape corresponding to the request item information.

According to an embodiment, the user device 110 may provide guidance to a route based on the received some of the second map data. The user device 110 may provide guidance to the route by outputting the some of the second map data that is received by being converted based on processing performance thereof.

For example, if the user device 110 is a low-specification (first specification) device (e.g., HUD), the user device may receive and output some of the second map data including a designated number (e.g., two) of lanes, including a driving lane corresponding to a current location and lanes on both sides of the driving lane. For example, the user device 110 having low specifications may receive and output some of the second map data, including a designated number of lanes (carriageways) including a driving lane upon lane change and a lane in a direction toward which a lane change will be performed. For example, the user device 110 having low specifications may output some of the second map data provided to highlight a caution section—for example, a caution section has been expanded in the form of a three-dimensional shape image—. The caution section may include at least one section, among a sink hole area on a road, an area in which shards of an accident vehicle are present, an area in which curbstones are present, or an area in which a gas station is present, for example.

For example, if the user device 110 is a high-specification (second specification) device (e.g., an autonomous vehicle), the user device may output some of the second map data having resolution not reduced (converted) without any change. The user device 110 may receive some of the second map data all at once, for example, and may output an area corresponding to a current location in the received some of the second map data while updating the area based on a change in the current location. The some of the second map data may be provided to have the second resolution, and may include a road, a road facility, a surrounding facility, and a varying object in the form of a three-dimensional shape image. Furthermore, the user device 110 having high specifications may display a signal state (e.g., green light turn-on and other traffic light blinking) in association with a traffic light object among road facilities—for example, overlapping a traffic light object image.

According to an embodiment, the server device 120 may be a computing device that is managed by an entrepreneur apparatus related to a route guidance service. The server device 120 may store the second map data provided to have the second resolution. The second resolution may be HD or higher resolution (e.g., Full HD), for example.

According to an embodiment, when receiving route information and request item information from the user device 110, the server device 120 may determine or generate some of the second map data corresponding to the request item information and the route information, among all of the second map data.

For example, the server device 120 may select some of the second map data including all of sections of a retrieved route (or a section within a designated distance from a current location), among all of the second map data, based on the route information. The server device 120 may generate some of the second map data by excluding an object except the type of object according to the request item information from the some of the second map data.

For example, the server device 120 may generate some of the second map data by converting at least one object according to request item information received from the user device 110 in a two-dimensional shape. For example, if request item information includes an unused request for a three-dimensional shape for at least some of object types, the server device 120 may generate some of the second map data in which an image of some objects has been substituted with a two-dimensional shape image instead of a default three-dimensional shape image. In this process, the server device 120 may convert some of the second map data into data having resolution (e.g., may be the same as the first resolution) lower than the second resolution.

According to various embodiments, the user device 110 may update location information as the location of a vehicle is moved. The user device 110 may transmit the updated location information to the server device 120. The server device 120 may generate some of the second map data corresponding to the updated location information, and may provide the some of the second map data to the user device 110.

According to various embodiments, at least some of an operation performed by the server device 120 may be performed by the user device 110. Furthermore, some of an operation performed by the user device 110 may be performed by the server device 120.

As described above, when receiving map data (some of the second map data) corresponding to the specifications (processing performance) of the user device 110 from the server device 120 in which high-precision map data (the second map data) have been stored, the route guidance system 10 according to an embodiment may output the map data for route guidance in the user device 110 mounted on the existing vehicle.

Furthermore, the route guidance system 10 according to an embodiment may output some (e.g., driving lane information) of the second (high-precision) map data according to the specifications of the user device 110 although the user device 110 mounted on the existing vehicle has not stored high-quality map data or has low specifications in processing high-quality map data.

Furthermore, the route guidance system 10 according to an embodiment may provide an image that requires caution upon driving, such as shards of an accident vehicle or a sink hole on a road, in a form in which user visibility can be enhanced.

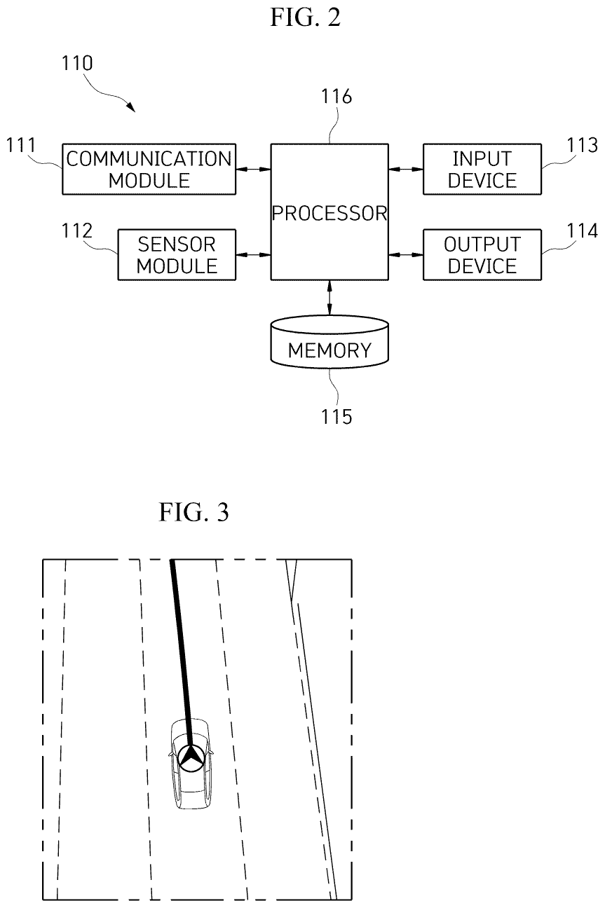

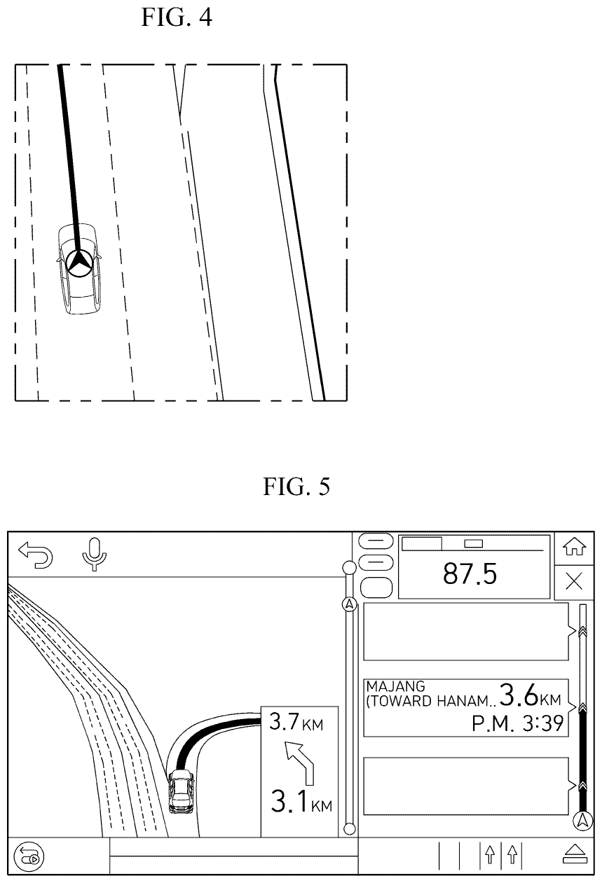

FIG. 2 illustrates a construction diagram of the user device according to an embodiment. FIGS. 3, 4, and 5 illustrate examples of route guidance screens according to an embodiment.

Referring to FIG. 2, the user device 110 according to an embodiment may include a communication module 111, a sensor module 112, an input device 113, an output device 114, memory 115, and a processor 116. In an embodiment, some components of the user device 110 may be omitted or an additional component may be further included in the user device. Furthermore, some of the components of the user device 110 may be combined into one entity, but may identically perform a function of corresponding components prior to the combination.

The sensor module 112 may include at least one first sensor, among a GPS sensor, an acceleration sensor, or a gyro (angular velocity) sensor. The first sensor may sense location coordinates (e.g., latitude and longitude) of the user device 110 under the control of the processor 116. The sensor module 112 may be a second sensor that is provided to be capable of sensing at least one a turn indicator, a vehicle pedal state, or a vehicle speed. The second sensor may be provided in a vehicle control unit (e.g., a body control unit (BCM) or an engine control module (ECM)), and may transmit and receive detection-related data to and from the processor 116 through the communication module 111. The sensor module 112 may include at least one third sensor, among a LIDAR sensor, a radar sensor, an infrared sensor, or an image sensor. The third sensor may sense a surrounding environment (e.g., front, side, or rear) state of a vehicle (or another moving body) including the user device 110 under the control of the processor 116.

The input device 113 may receive or detect a user input (setting). The input device 113 may include at least one input detection circuit, among a button, a touch screen, and a microphone, for example.

The output device 114 may visually or audibly output at least one datum, among a symbol, a number, or a character, under the control of the processor 116. The output device 123 may include at least one output device, among a liquid crystal display, an OLED, a touch screen display, and a speaker, for example. In this document, a case in which the output device 114 is displayed is described as an example. However, the present disclosure is not limited thereto.

The communication module 111 may establish a communication channel or a wireless communication channel between the user device 110 and another apparatus (e.g., the server device 120), and may support the execution of communication through the established communication channel. The communication channel may include a communication channel using a communication method, such as WiFi, Wibro, Bluetooth, 3G, 4G, or 5G, for example. The communication channel may include vehicle to vehicle (V2V), vehicle to infrastructure (V2I), vehicle to nomadic device (V2N), and vehicle to pedestrian (V2P) communication. The communication channel may include at least one channel, among a controller area network (CAN) or media oriented systems transport (MOST).

The memory 115 may store various data that are used by at least one component (e.g., the processor 116) of the user device 110. The data may include software and input data or output data for a command related thereto, for example. For example, the memory 115 may store at least one instruction for providing a route guidance service based on the first map data. The memory 115 may store the first map data provided to have the first resolution (e.g., SD resolution) and instructions related to the execution of a first application for a route guidance service based on some of the second map data. The some of the second map data may be provided by the server device 120.

The memory 115 may include various forms of volatile memory or nonvolatile memory. For example, the memory may include read only memory (ROM) and random access memory (RAM). In an embodiment of this specification, the memory may be disposed inside or outside the processor. The memory 115 may be connected to the processor 116 through various already-known means.

The processor 116 may control at least another component (e.g., hardware or software component) of the user device 110, and may perform various data processing or operation. The processor 116 may include at least one of a central processing unit (CPU), a graphic processing unit (GPU), a microphone processor, an application processor, an application specific integrated circuit (ASIC), a field programmable gate arrays (FPGA), for example, and may have a plurality of cores.

According to an embodiment, the processor 116 may confirm an executable item according to processing specifications thereof when the first application is installed, and may automatically set request item information corresponding to the confirmed executable item. For example, when the first application is installed, the processor 116 may confirm an executable item corresponding to processing performance (specifications) of the user device 110. The processing performance may be confirmed based on specification information (e.g., CPU standard) of the processor 116, which is stored in the memory 115, and specification information (e.g., resolution) of the output device 114. The processor 116 may automatically set request item information related to the use (or some) of the second map data based on the confirmed executable item in the first application. In an embodiment, the processor 116 may change and set request item information based on a user's input (e.g., select a requested item and release the selection) through the input device 113.

According to an embodiment, the processor 116 may sense a vehicle location and a lane change state (e.g., the turn-on/blinking of a turn indicator of a vehicle) by using the sensor module 112, and may generate location information and vehicle change information based on the results of the sensing. The location information may include a driving direction and a driving lane in addition to geographical location information (e.g., latitude and longitude).

According to an embodiment, when route search for a destination is requested through the input device 113, the processor 116 may search for a route based on the first map data in response to the request. For example, the processor 116 may receive information related to an object, such as a signal state, a traffic state, or a varying object, from the server device 120 through the communication module 111 during route search, and may search for an optimal route with reference to the received information related to the object.

According to an embodiment, the processor 116 may check route information retrieved based on the first map data and confirm request item information stored in the memory 115 when route search is completed. The route information may include the link ID of a link according to a standard node link that connects nodes according to the standard node included in the first map data, for example. The route information may include current location information (e.g., geographical location coordinates, a driving direction, a driving lane (e.g., a three-lane road)), or lane change information of a vehicle. The request item information may include at least piece of information, among information on the type of object to be requested, information on the number of requested lanes (hereinafter corresponding to a “designated number”), information on requested resolution, or information on the use/unused status of a three-dimensional shape image, for example. The type of object may include at least one object, among a lane, a road, a road facility (e.g., a traffic sign, a traffic light, or a curbstone), a signal state (e.g., a traffic light turn-on/blinking state), a traffic state (e.g., congested or slowing down), a surrounding facility (e.g., a gas station or a restaurant), or a varying object (e.g., a sink hole or shards of an accident vehicle), for example.

According to an embodiment, the processor 116 may transmit a first message related to a request for some of the second map data corresponding to request item information and route information to the server device 120 through the communication module 111. The processor 116 may receive some of the second map data corresponding to the request item information and the route information as a response to the first message from the server device 120 through the communication module 111. According to an embodiment, the processor 116 may provide a user with guidance to a route to a destination by outputting some of the second map data corresponding to the request item information and the route information to the output device 114. The some of the second map data may include a section corresponding to a current location based on the route information, among all of the second map data. The some of the second map data may include an object having a type corresponding to the request item information in the second map data as resolution and a shape corresponding to the request item information.

According to an embodiment, if the user device 110 has high specifications, the processor 116 may receive some of the second map data corresponding to request item information from the server device 120 all at once with respect to all of sections included in route information. In contrast, if the user device 110 has low specifications, the processor 116 may receive some of the second map data corresponding to the request item information with respect to a section (hereinafter may be referred as “corresponding to a current location”) within a designated distance (e.g., 5 km) in the entry direction of a vehicle from a current location, among all of sections included in the route information. In this document, for convenience of description, a case in which the processor 116 receives some of the second map data corresponding to a current location from the server device 120 is described as an example. However, the present disclosure is not limited thereto.

In an embodiment, request item information corresponding to processing performance of low specifications may include a request for an object related to a lane, a road, a road facility, a surrounding facility, and a varying object in the form of an image having second resolution (or first resolution), and a request for an image including a traffic state, a signal state and a driving lane, and a designated number (e.g., a first designated number) of lanes or less.

Referring to FIG. 3, the processor 116 having low specifications may sense a current location and driving lane of a vehicle by using the sensor module 112, for example, and may transmit, to the server device 120, a first message related to request item information and route information including the current location, a driving direction, and the driving lane. The server device 120 may generate and transmit some of a second map image as a response to the first message so that a designated number (e.g., 3) of lanes including the driving lane corresponding to the current location and the request item information and lanes that neighbor both sides of the driving lane, respectively. The processor 116 may receive some of the second map image from the server device 120 and output the some of the second map image through the output device 114. For example, as illustrated in FIG. 3, the some of the second map data may include a total of three roads including a driving lane and lanes that neighbor both sides of the driving lane, respectively. In another embodiment, if a driving lane is one lane or the outermost lane, the some of the second map data may include the driving lane and only one lane that neighbors the driving lane in one direction.

Referring the processor 116 having low specifications may sense the turn-on of a turn indicator for a first direction (e.g., a left direction) by using the sensor module 112, for example, and may transmit a first message related to the first direction to the server device 120. The processor 116 may receive some of the second map data provided to be capable of outputting a designated number of lanes including a driving lane and a lane that neighbors the driving lane in the first direction as a response to the first message from the server device 120. For example, as illustrated in FIG. 4, the some of the second map data may include a total of three lanes including a driving lane and two lanes that neighbor the driving lanes in a lane change direction.

For example, the processor 116 having low specifications provides guidance to a route based on the first map data, but may output the route by highlighting, on the first map data, a caution section checked based on some of the second map data—for example, the caution section in an enlarged image having a three-dimensional shape—. The processor 116 may provide guidance to at least one section, among a sink hole area, an area in which shards of an accident vehicle are present, an area in which curbstones are present, or an area in which a gas station is present on a road, in a three-dimensional shape based on some of the second map data while providing guidance to a route based on the first map data, for example.

In an embodiment, request item information corresponding to processing performance of high specifications may be a request for all types of objects, such as a lane, a road, a road facility, a surrounding facility, a traffic state, and a signal state, in a three-dimensional shape identically with the second map data while requesting a image having the second resolution. The request item information may further include vehicle information (a driving lane, a driving direction, or a designated number).

Referring to FIG. 5, the user device 110 having high specifications may output some of the second map data corresponding to request item information and route information in a three-dimensional shape without the conversion of resolution, for example. By transmitting a first message related to location information to the server device 120, for example, the processor 116 may receive some of the second map data corresponding to a change in a current location and output the some of the second map data through the output device 114. In this case, the some of the second map data may include a designated number of lanes (e.g., may be all of lanes of a corresponding road) corresponding to the request item information.

According to the embodiment, the processor 116 provides route guidance based on a first map image, but may display the route guidance by highlighting (e.g., overlap or in the form of a three-dimensional image) only a section to be cautioned based on a second map image.

According to various embodiments, the processor 116 may check a traffic state and varying object for each lane based on some of the second map data, and may search for an optimal route again based on the traffic state and varying object for each lane. The processor 116 may provide guidance to a lane change through the output device 114 based on the re-retrieved optimal route. In various embodiments, the processor 116 may provide a user with guidance to a traffic state for each lane through the output device 114.

As described above, the user device 110 according to an embodiment may display a surrounding lane image of a driving lane in addition to the driving lane by receiving some of the second map data corresponding to specifications (processing performance) of the user device 110 from the server device 120.

Furthermore, the user device 110 according to an embodiment may output a caution section according to a varying object on a road, such as shards of an accident vehicle or a sink hole on a road, in a form in which user visibility can be increased based on a three-dimensional image received from the server device 120 although the user device has not stored map data having high picture quality.

Furthermore, the user device 110 according to an embodiment may check a traffic state in a lane unit based on a second map image having high picture quality, and may provide (output) a traffic situation in the lane unit to a user.

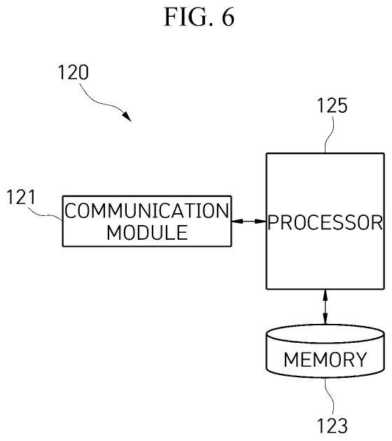

FIG. 6 illustrates a construction of a server device according to an embodiment.

Referring to FIG. 6, the server device 120 according to an embodiment may include a communication module 121, memory 123, and a processor 125. In an embodiment, some components of the server device 120 may be omitted or an additional component may be further included in the server device 120. Furthermore, some of the components of the server device 120 may be combined into one entity, but may identically perform a function of corresponding components prior to the combination.

The communication module 121 may establish a communication channel or a wireless communication channel between the server device 120 and another apparatus (e.g., the user device 110), and may support the execution of communication through the established communication channel. The communication channel may be a communication channel using a communication method, such as a LAN, FTTH, xDSL, WiFi, Wibro, 3G, 4G, or 5G, for example. The communication channel may include at least one communication channel, among vehicle to vehicle (V2V), vehicle to infrastructure (V2I), vehicle to nomadic device (V2N), and vehicle to pedestrian (V2P) communication.

The memory 123 may store various data that are used by at least one component (e.g., the processor 125) of the server device 120. The data may include input data or output data for software and a command related to the software, for example. For example, the memory 123 may store at least one instruction for providing a route guidance service based on the second map data. The memory 123 may store the second map data provided to have the second resolution and information related to an object included in the second map data. The memory 123 may store at least one instruction for generating some of the second map data corresponding to request item information and route information. The second map data may include at least one object, among a lane, a road, a road facility, a surrounding facility, or a varying object in the form of a three-dimensional shape image. The second map data may include a signal state (e.g., a traffic light turn-on/blinking state) and a traffic state (e.g., congested or slowing down) that are incorporated in real time or may be related thereto.

The memory 123 may m include various forms of volatile memory or nonvolatile memory. For example, the memory may include read only memory (ROM) and random access memory (RAM). In an embodiment of this specification, the memory may be disposed inside or outside the processor. The memory 123 may be connected to the processor 125 through various already-known means.

The processor 125 may control at least another component (e.g., hardware software component) of the server device 120, and may perform various data processing or operations. The processor 125 may include at least one of a central processing unit (CPU), a graphic processing unit (GPU), microphone processor, an application processor, an application specific integrated circuit (ASIC), and a field programmable gate arrays (FPGA), for example, and may have a plurality of cores.

According to an embodiment, the processor 125 may receive a traffic state, a signal state, and information related to an object, such as a varying object, in real time from another sensor module through the communication module 121, and may relate (include) information related to a changed object to (in) the second map data based on the received information.

According to an embodiment, the processor 125 may receive and check a first message related to route information and request item information corresponding to processing performance of the user device 110 from the user device through the communication module 121. The route information may include the link ID of a link according to a standard node link that connects nodes according to the standard node included in the first map data, for example. The route information may include current location information (e.g., geographical location coordinates, a driving direction, or a driving lane (e.g., a three-lane road)) and lane change information of a vehicle.

According to an embodiment, the processor 125 may select some of the second map data including all of sections (or a section within a designated distance from a current location) of a retrieved route, among all of the second map data, based on route information. The processor 125 may generate some of the second map data by excluding an object except the type of object according to request item information from the some of the second map data. For example, the processor 125 may generate some of the second map data by converting at least one object according to request item information received from the user device 110 in a two-dimensional shape. For example, if request item information includes an unused request for a three-dimensional shape for at least some of object types, the processor 125 may generate some of the second map data in which an image of some objects has been substituted with a two-dimensional shape image instead of a default three-dimensional shape image. In this process, the processor 125 may convert resolution of the some of the second map data into resolution (e.g., may be the same as the first resolution) lower than the second resolution. For example, the processor 125 may generate (or select) some of the second map data so that the some of the second map data includes a designated number of lanes according to request item information (e.g., information on the number of lanes). The processor 125 may determine some of the second map data by converting the generated (or selected) some of the second map data into the first resolution according to the request item information (e.g., resolution information). If the second map data converted into the first resolution have been stored in the memory 123, the processor 125 may select (load) some of the second map data provided to have the first resolution from the memory 123.

According to an embodiment, the processor 125 may provide the user device 110 with generated some of the second map data through the communication module 121. The processor 125 may periodically receive location information of the user device 110 through the communication module 121, and may transmit some of the second map data through the communication module 121 by updating the some of the second map data based on a location change.

As described above, the server device 120 according to an embodiment may support the user device 110 so that the user device can easily check real-time road state information by providing the second map data (high-precision map data) so that the second map data (high-precision map data) correspond to specifications (processing performance) of the user device 110 by converting the second map data (high-precision map data).

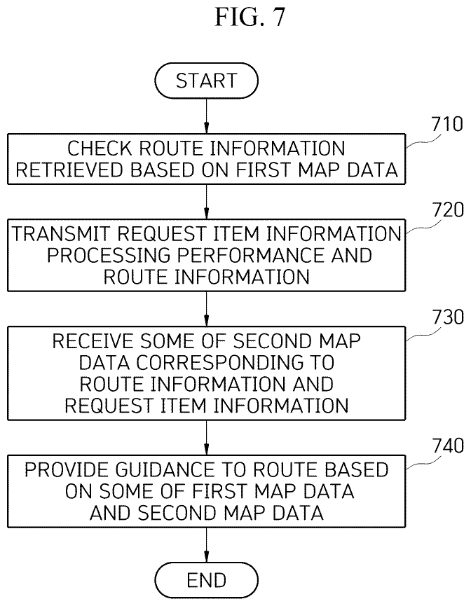

FIG. 7 illustrates a flowchart of a route guidance method according to an embodiment.

Referring to FIG. 7, in operation 710, the user device 110 may check route information retrieved based on the first map data provided to have the first resolution and request item information if route search has been performed. The route information may include the link ID of a link according to a standard node link that connects nodes according to the standard node link included in the first map data, for example. The route information may include current location information (e.g., geographical location coordinates, a driving direction, a driving lane (e.g., a three-lane road)), and lane change information of a vehicle. The request item information may include at least piece of information, among information on the type of object to be requested, information on the number of requested lanes (hereinafter corresponding to a “designated number”), information on requested resolution, or information on the use/unused status of a three-dimensional shape image, for example.

In operation 720, the user device 110 may transmit a first message related to a request for some of the second map data corresponding to the request item information and the route information, among all of the second map data.

In operation 730, the user device 110 may receive some of the second map data corresponding to the request item information and the route information from the server device 120 as a response to the first message. The some of the second map data may include a section corresponding to a current location according to the route information, among all of the second map data. The some of the second map data may include an object having a type corresponding to the request item information as resolution and a shape corresponding to the request item information in the second map data.

In operation 740, the user device 110 may provide guidance to a route based on the received some of the second map data or the first map data and some of the second map data.

As described above, the user device 110 according to an embodiment may provide guidance to a route based on information that is more precise than the first map data, by receiving some of the second map data corresponding to specifications (processing performance) of the user device from the server device 120.

Various embodiments of this document and terms used in the embodiments are not intended to limit the technical characteristics, described in this document, to specific embodiments, and should be understood as including various changes, equivalents or alternatives of a corresponding embodiment. In relation to the description of the drawings, similar reference numerals may be used for similar or related components. A singular form of a noun corresponding to an item may include one item or a plurality of items unless explicitly described otherwise in the context. In this document, each of phrases, such as “A or B”, “at least one of A and B”, “at least one of A or B”, “A, B or C”, “at least one of A, B, and C”, and “at least one of A, B, or C”, may include any one of items listed along with a corresponding one of the phrases or all possible combinations of the listed items. Terms, such as “a first”, “a second”, or “the first” or “the second”, may be used to merely distinguish between a corresponding component and another corresponding component, and do not limit corresponding components in another aspect (e.g., importance or a sequence). If any (e.g., a first) component is described as being “coupled” or “connected” to another (e.g., a second) component along with a term “functionally” or “communicatively” or without such a term, this means that the any component may be coupled to the another component directly (e.g., in a wired way), wirelessly, or through a third component.

The term “module” used in various embodiments of this document may include a unit implemented as hardware, software or firmware, and may be interchangeably used with a term, such as logic, a logical block, a part, or a circuit. The module may be an integrated part, or a minimum unit of the part or a part thereof, which performs one or more functions. For example, according to an embodiment, the module may be implemented in the form of an application-specific integrated circuit (ASIC).

Various embodiments of this document may be embodied as software (e.g., a program) including one or more instructions stored in a storage medium (e.g., the memory 115 in FIG. 2) (e.g., embedded memory or external memory) readable by a machine (e.g., an electronic device). For example, a processor (e.g., the processor of a device (e.g., the user device 110 or the server device 120) may invoke at least one of the one or more instructions stored in the storage medium, and may execute the instruction. This enables the machine to operate to perform at least one function based on the invoked at least one instruction. The one or more instructions may include a code generated by a complier or a code executable by an interpreter. The machine-readable storage media may be provided in the form of a non-transitory storage medium. In this case, “non-transitory” merely means that the storage medium is a tangible device and does not include a signal (e.g., electromagnetic wave). The term does not distinguish between a case where data is semi-permanently stored in the storage medium and a case where data is temporally stored in the storage medium.

According to an embodiment, the method according to various embodiments disclosed in this document may be included in a computer program product and provided. The computer program product may be traded as a product between a seller and a purchaser. The computer program product may be distributed in the form of a machine-readable storage medium (e.g., a compact disc read only memory (CD-ROM)) or may be distributed through an app store (e.g., PlayStore™) or directly between two user devices (e.g., smartphones) or online (e.g., download or upload). In the case of the online distribution, at least some of the computer program products may be at least temporarily stored or provisionally generated in a machine-readable storage medium, such as the memory of the server of a manufacturer, the server of an app store or a relay server.

The components according to various embodiments of the present disclosure may be implemented in the form of software or hardware, such as a digital signal processor (DSP), a field programmable gate array (FPGA) or an application-specific integrated circuit (ASIC), and may perform given roles. The “components” are not components having meanings limited to software or hardware, and each component may be configured to reside on an addressable storage medium and may be configured to operate one or more processors. For example, the component may include components, such as software components, object-oriented software components, class components, and task components, processes, functions, attributes, procedures, sub-routines, segments of a program code, drivers, firmware, a microcode, circuitry, data, a database, data structures, tables, arrays, and variables.

According to various embodiments, each (e.g., a module or a program) of the aforementioned components may include a single entity or a plurality of entities. According to various embodiments, one or more components or operations of the aforementioned components may be omitted or one or more other components or operations may be added. Alternatively or additionally, a plurality of components (e.g., modules or programs) may be integrated into a single component. In such a case, the integrated component may identically or similarly perform a function performed by a corresponding one of the plurality of components before one or more functions of each of the plurality of components are integrated. According to various embodiments, operations performed by a module, a program, or another component may be executed sequentially, in parallel, iteratively or heuristically, or one or more of the operations may be executed in different order or may be omitted, or one or more other operations may be added.

1. An electronic device comprising:
memory in which first map data provided to have first resolution are stored;
a communication module provided to be capable of communicating with an external electronic device, wherein the external electronic device stores second map data provided to have second resolution higher than the first resolution and related to a three-dimensional shape; and
a processor functionally connected to the communication module and the memory,
wherein the processor
checks route information retrieved based on the first map data when route search is performed,
transmits a first message related to a request for some of the second map data corresponding to request item information according to processing performance of the electronic device and the route information, among all of the second map data, to the external electronic device through the communication module, and
receives some of the second map data corresponding to the request item information and the route information, as a response to the first message, from the external electronic device through the communication module.

2. The electronic device of claim 1, further comprising:
an output device; and
a sensor module provided to be capable of sensing a location,
wherein the processor
senses a current location of the electronic device through the sensor module, and
receives some of the second map data corresponding to the current location and outputs the some of the second map data through the output device.

3. The electronic device of claim 2, wherein when the processing performance has first specifications, the processor
checks a section to be cautioned, which is related to the current location, among the some of the second map data, and
outputs information related to the section to be cautioned through the output device by highlighting the information related to the section.

4. The electronic device of claim 2, wherein when the processing performance has first specifications, the processor outputs information on a designated number of lanes comprising a driving lane corresponding to the current location and lanes that neighbor both sides of the driving lane, among the some of the second map data.

5. The electronic device of claim 4, wherein
the sensor module is provided to be capable of further sensing whether a vehicle is to perform a lane change, and
the processor outputs the information on the designated number of lanes comprising a lane that neighbors a direction of a lane change by transmitting the first message related to the direction of the lane change when sensing an attempt on the lane change of the vehicle through the sensor module.

6. The electronic device of claim 2, wherein the processor outputs some of the second map data, which has the second resolution, when the processing performance has second specifications capable of displaying the second resolution.

7. The electronic device of claim 1, wherein:
the request item information comprises at least one of information on a type of object to be requested, information on a number of lanes to be requested, information on requested resolution, and information on a use/unused status of a three-dimensional shape, which are included in or related to the second map data, and
the information on the type of object is related to at least one type of object, among a lane, a road, a signal, a traffic state, a facility, and a varying object.

8. An electronic device comprising:
a communication module provided to be capable of communicating with an external electronic device;
memory in which first map data comprising three-dimensional shape information are stored; and
a processor functionally connected to the communication module and the memory,
wherein the processor
checks route information on a destination and request item information corresponding to processing performance of the external electronic device through the communication module when the external electronic device transmits the route information and the request item information,
selects first map data related to the route information, among all of the first map data,
determines some of the first map data corresponding to the request item information by excluding information except the request item information from the selected first map data, and
transmits the some of the first map data to the external electronic device through the communication module.

9. The electronic device of claim 8, wherein:
the request item information comprises at least one of information on a type of object to be requested, information on a number of lanes to be requested, information on requested resolution, and information on a use/unused status of a three-dimensional shape, which are included in or related to the second map data, and
the information on the type of object is related to at least one type of object, among a lane, a road, a signal, a traffic state, a facility, and a varying object.

10. The electronic device of claim 9, wherein
the request item information comprises the information on the number of lanes to be requested and the information on the requested resolution, and
the processor selects the first map data so that the first map data comprises the designated number of lanes according to the information on the number of lanes and determines the first map data by converting the selected first map data into resolution corresponding to the information on the resolution.
